(19) United States
(12) Patent Application Publication
(10) Pub. No.: US 2007/0283399 A1
(43) Pub. Date: Dec. 6, 2007

(54) Channel table processing system and method

(75) Inventors: Steven L. Cooper, Whitestown, IN (US); Bret D. Hawkins, Brownsburg, IN (US); James D. Tenbarge, Fishers, IN (US)

Correspondence Address: FLETCHER YODER, P.O. BOX 692289, HOUSTON, TX, 77269-2289, US

(73) Assignee: Schenzhen TCL New Technology LTD

(21) Appl. No.: 11/809,506

(22) Filed: Jun. 1, 2007

Related U.S. Application Data
(60) Provisional application No. 60/810,313, filed on Jun. 2, 2006.

(51) Int. Cl. H04N 7/173; H04N 7/16

(52) U.S. Cl. 725/100; 725/118; 725/135

(57) ABSTRACT

An exemplary method of operating an electronic device comprises updating a channel map. The method further comprises prohibiting further updating of the channel map for a predetermined time, and permitting further updating of the channel map after expiration of the predetermined time.

### CROSS REFERENCE TO RELATED APPLICATION

This application claims priority based on U.S. Provisional Application Ser. No. 60/810,313 filed on Jun. 2, 2006, which is incorporated by reference as though completely set forth herein.

### BACKGROUND

This section is intended to introduce the reader to various aspects of art which may be related to various aspects of the present invention that are described below. This discussion is believed to be helpful in providing the reader with background information to facilitate a better understanding of the various aspects of the present invention. Accordingly, it should be understood that these statements are to be read in this light, and not as admissions of prior art.

In a typical digital cable system, channel information is provided in the form of tables specified by the ANSI/SCTE 65 standard from an out-of-band (OOB) radio frequency (RF) source. The OOB source specifies all channels existing on the cable feed,and overrides the information found using a traditional channel search. This OOB guide can hide channels or move them to other frequencies or virtual channel numbers.

The ANSI/SCTE 65 standard differs from the ATSC 65 standard in its specification of possible tables containing the information about a cable channel map. There are currently six table “profiles” for digital-cable-ready systems. Many of these profiles contain table types that do not require revision descriptors. These revision descriptors are used in the higher level profiles to identify the tables being sent. If revision descriptors are used, it is easy to determine when new tables arrive by a simple comparison of revision descriptors. Without the descriptors it is difficult to determine when new tables arrive and the information acquired from older tables needs to be modified or discarded.

A related problem in using tables without revision descriptors is that it is difficult to determine whether a received table is intended to replace an older table or is just intended to provide additional information to the existing table. By way of example, channels 0-99 could be described in table 1A, channels 100-199 in table 1B, and channels 200-4096 in table 1C. If a new table of type 1 arrives that differs from the previous tables, it needs to be determined if it updates, overrides, or provides additional channel information. For the higher level profiles where the revision descriptor is present, it is possible to determine that 1A, 1B, 1C, and the new arrival belong to the same set because they all have the same revision descriptor.

Without the revision descriptor, a known method of determining new table arrival is by doing a comparison of the CRC fields found in previously sent tables. When a table arrives and its CRC matches one of the previously-seen tables, it was assumed that a “wrap” occurred. This meant that all tables of that type were assumed to have been received. Anything new after that point would be assumed to be new, possibly conflicting data. In such a situation, the old channel map would be destroyed and a new one would be created using the new information. During rebuilding of the channel map, a short period of time would elapse during which the channel map would contain only partial channel information. This could cause confusion to the user if it occurred while he/she was trying to navigate the channel map, for example, to change channels.

Unfortunately, if tables are sent out of order or frequently dropped due to bandwidth limitations, the wrap detection method would be incorrectly triggered. This could cause the partial channel map scenario to occur much more frequently than expected. In some conditions, rebuilding of the channel map could occur every few minutes as opposed to every few weeks, which would be undesirable from a perspective of system reliability.

A further issue in the handling of channel maps is the amount of memory needed to hold a channel map. For example, it is theoretically possible to have a digital cable ready system with as many as 16,843 possible channels, each with textual descriptions and other information. As the number of channels gets larger, size and cost of system memory grows as well. In some systems having limited amounts of embedded memory, it may not be practical to create duplicate channel maps in memory. Thus, the device could be unable to work with one channel map while the new one was being acquired.

### BRIEF DESCRIPTION OF THE DRAWINGS

In the drawings:

FIG. 1 is a block diagram of an electronic device that may employ an embodiment of the present invention; and

FIG. 2 is a process flow diagram illustrating a method in accordance with an exemplary embodiment of the present invention.

### DETAILED DESCRIPTION OF THE PREFERRED EMBODIMENT

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

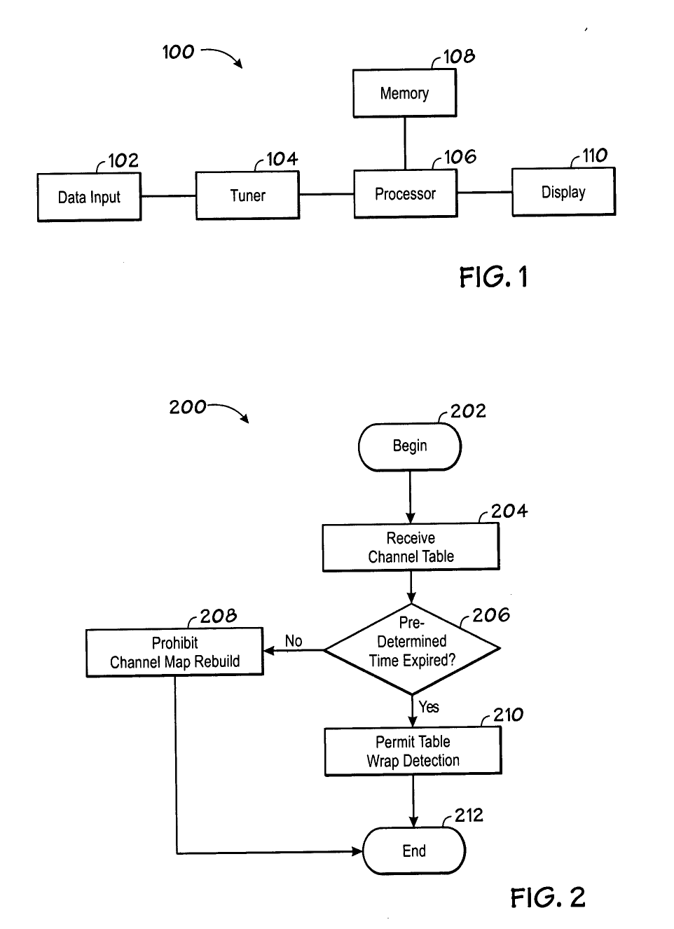

FIG. 1 is a block diagram of an electronic device that may employ an embodiment of the present invention. The electronic device is generally referred to by the reference number 100. The electronic device 100 (for example, a television, a digital video recorder (DVR), a digital cable ready set top box or the like) comprises a data input 102, a tuner 104, a processor 106 and a memory 108. The memory 108 may be adapted to hold machine-readable computer code that causes the processor 106 to perform an exemplary method in accordance with the present invention.

FIG. 2 is a process flow diagram illustrating a method in accordance with an exemplary embodiment of the present invention. An exemplary embodiment of the present invention is adapted to address the problems that occur when channel tables are sent out of order, or are frequently missed or dropped. One exemplary embodiment of the invention delays application of a table wrap operation for a predetermined amount of time.

In a typical digital cable ready system, channel tables are specified to arrive at given intervals. Therefore, it is possible to determine a reasonable time period during which all channel tables specifying a complete cable channel map should have arrived and been correctly received. The time period may be measured by a timer and may start upon receipt of a channel table. Alternatively, the time period may be started arbitrarily at a particular time of day or at a given time interval, each of which may be chosen to correspond with a known or assumed channel table transmission time. During the predetermined time period, it may be assumed that no channel table wrap has occurred, so rebuilding of the channel table may be prohibited. After the time period expires, wrap detection is allowed to begin. Thus, in an exemplary embodiment of the present invention, channel tables are gathered for a given period of time. After that time, if a table of a certain type arrives that has already been seen, then the wrap detect would be triggered. After that point, any new table of a given type, determined by its CRC, would cause the reacquisition of the data for that table type.

An exemplary embodiment of the present invention allows a channel map to remain stable so that the user is able to navigate to all possible channels without interruption. Disruptions to the channel map during periods of time other than the infrequent times when the cable operator actually performs changes to the channel map could be reduced.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method of operating an electronic device, comprising:
updating a channel map;
prohibiting further updating of the channel map for a predetermined time; and
permitting further updating of the channel map after expiration of the predetermined time.

2. The method recited in claim 1, wherein updating the channel map comprises rebuilding the channel map.

3. The method recited in claim 1, comprising receiving a channel table that includes information about at least a portion of the channel map via an out-of-band radio frequency source.

4. The method recited in claim 1, wherein the channel map is updated using at least one channel table that conforms to an ANSI/SCTE 65 standard.

5. The method recited in claim 4, wherein the at least one channel table does not contain revision descriptors.

6. The method recited in claim 1, wherein the predetermined time is started in response to the updating of the channel map.

7. The method recited in claim 1, wherein the predetermined time is started at the same time each day.

8. The method recited in claim 1, wherein the electronic device comprises a television.

9. An electronic device, comprising:
a signal input that is adapted to receive a channel table;
a display that is adapted to display images based on an input received via the signal input; and
a processor that is adapted to prohibit updating of a channel map based on the channel table for a predetermined time and to permit updating of the channel map after expiration of the predetermined time.

10. The electronic device recited in claim 9, wherein updating the channel map comprises rebuilding the channel map.

11. The electronic device recited in claim 9, wherein the channel table is received via an out-of-band radio frequency source.

12. The electronic device recited in claim 9, wherein the channel table conforms to an ANSI/SCTE 65 standard.

13. The electronic device recited in claim 9, wherein the channel table does not contain revision descriptors.

14. The electronic device recited in claim 9, wherein the predetermined time is started in response to the updating of the channel map.

15. The electronic device recited in claim 9, wherein the predetermined time is started at the same time each day.

16. The electronic device recited in claim 9, wherein the electronic device comprises a television.

17. An electronic device, comprising:
means for updating a channel map;
means for prohibiting further updating of the channel map for a predetermined time; and
means for permitting further updating of the channel map after expiration of the predetermined time.

18. The electronic device recited in claim 17, wherein the channel map is updated using at least one channel table that does not contain revision descriptors.

19. The electronic device recited in claim 17, wherein the predetermined time is started in response to updating the channel map.

20. The electronic device recited in claim 17, wherein the predetermined time is started at the same time each day.
